(19) United States
(12) Patent Application Publication
(10) Pub. No.: US 2008/0036174 A1
(43) Pub. Date: Feb. 14, 2008

(54) Enclosed boat trailer

(76) Inventor: Timothy C. Nieman, Greenwood, IN (US)

Correspondence Address: LITMAN LAW OFFICES, LTD., P.O. BOX 15035, CRYSTAL CITY STATION, ARLINGTON, VA, 22215, US

(21) Appl. No.: 11/889,139

(22) Filed: Aug. 9, 2007

Related U.S. Application Data
(60) Provisional application No. 60/836,386, filed on Aug. 9, 2006.

(51) Int. Cl. B60P 3/10

(52) U.S. Cl. 280/414.1

(57) ABSTRACT

The boat trailer includes a housing, for receiving a boat therein. The housing covers and supports the boat for storage or transport thereof. The housing includes an antechamber, an upper wall, a pair of sidewalls and at least one rear door. The trailer includes a front chassis and a rear chassis slidably engaging the front chassis, the housing being mounted on the front chassis. The rear chassis may be secured to the front chassis when drawn fully forward into the housing. The rear chassis supports a boat cradle or the like. A motor is housed in the antechamber and drives a linear translation system to extend the rear chassis from the trailer and draw the rear chassis back within the trailer. The linear translation system may be a chain and sprocket system driving rack and pinion gearing.

### CROSS-REFERENCE TO RELATED APPLICATION

This application claims the benefit of U.S. Provisional Patent Application Ser. No. 60/836,386, filed Aug. 9, 2006.

### BACKGROUND OF THE INVENTION

1. Field of the Invention

The present invention relates to boat trailers, and particular to an enclosed boat trailer for transporting and storing a boat therein.

2. Description of the Related Art

Small boats, such as motorboats and the like, are often stored on dry land and transported via truck or trailer to the water. Typically, such transports include an open trailer hitched to a motor vehicle, such as a truck or automobile, with the upper portion of the trailer being adapted for secure mounting of the boat thereon. Basic trailers often include a raised platform, cradle, or carriage that is supported on wheels. Most often, the front of the trailer is raised in order to slide the boat off of the trailer into the water, or to winch the boat back onto the trailer. Such basic trailers, however, only provide support for the boat during transport thereof, and provide no protection from the elements or external hazards such as, for example, flying gravel on the highway or bird droppings.

Further, such trailers typically include rollers or some other similar sliding means, allowing the boat to be manually pushed by the user or lowered by winch into the water. Such systems can damage the boat hull and require a great deal of physical exertion on the part of the user in manual systems. Also, while the boat is being deployed, and is only partially supported by the trailer base platform, the boat may become unbalanced and may tip or fall, thus causing expensive and dangerous injury to both the boat and to people or property in the vicinity. Thus, a boat trailer solving the aforementioned problems is desired.

### SUMMARY OF THE INVENTION

The boat trailer includes an enclosure, or housing, mounted on a wheeled chassis or frame for storing and transporting the boat within the enclosure. The housing includes an upper wall, a lower wall, a pair of sidewalls, a trapezoidal antechamber having a front door, and a roll-top rear door. The housing is dimensioned and configured so that the boat may be safely and securely mounted therein.

The chassis includes a double rear axle and is split to form a front section that extends from a trailer hitch through the forward rear axle, and a rear section that includes the rearward rear axle. The front chassis section supports the majority of the enclosure, including the antechamber, the upper wall, the sidewalls, and the roll-top rear door. The rear chassis section supports a cradle for supporting the boat, and may include a deck or lower wall. The rear chassis section is slidably extendable from the front chassis section, using an electronic motor mounted in the antechamber that drives a chain and sprocket mechanism that, in turn, drives a rack and pinion gear or other linear slide mechanism. The front and rear sections are releasably locked together by a locking mechanism accessed within the enclosure.

These and other features of the present invention will become readily apparent upon further review of the following specification and drawings.

### BRIEF DESCRIPTION OF THE DRAWINGS

FIG. 1 is a diagrammatic side view in section of an enclosed boat trailer according to the present invention, shown in a retracted configuration.

FIG. 2 is a diagrammatic side view in section of the enclosed boat trailer according to the present invention, shown in an extended configuration.

FIG. 3 is a diagrammatic top view in section of the enclosed boat trailer according to the present invention, shown in the extended configuration of FIG. 2.

FIG. 4 is a diagrammatic partial side view of a portion of the drive system of the enclosed boat trailer according to the present invention.

FIG. 5 is a diagrammatic partial front view of the drive system of the boat trailer according to the present invention.

FIG. 6 is a partial side view of another portion of the drive system of the boat trailer according to the present invention.

FIG. 7 is a diagrammatic side view in section of an alternative embodiment of the enclosed boat trailer according to the present invention, shown in a retracted configuration.

FIG. 8 is a diagrammatic side view in section of the enclosed boat trailer of FIG. 7, shown in an extended configuration.

FIG. 9 is a diagrammatic top view in section of the enclosed boat trailer of FIG. 7, shown in the extended configuration of FIG. 8.

FIG. 10 is a diagrammatic partial side view of a portion of the drive system of an alternative embodiment of the enclosed boat trailer according to the present invention.

Similar reference characters denote corresponding features consistently throughout the attached drawings.

### DETAILED DESCRIPTION OF THE PREFERRED EMBODIMENTS

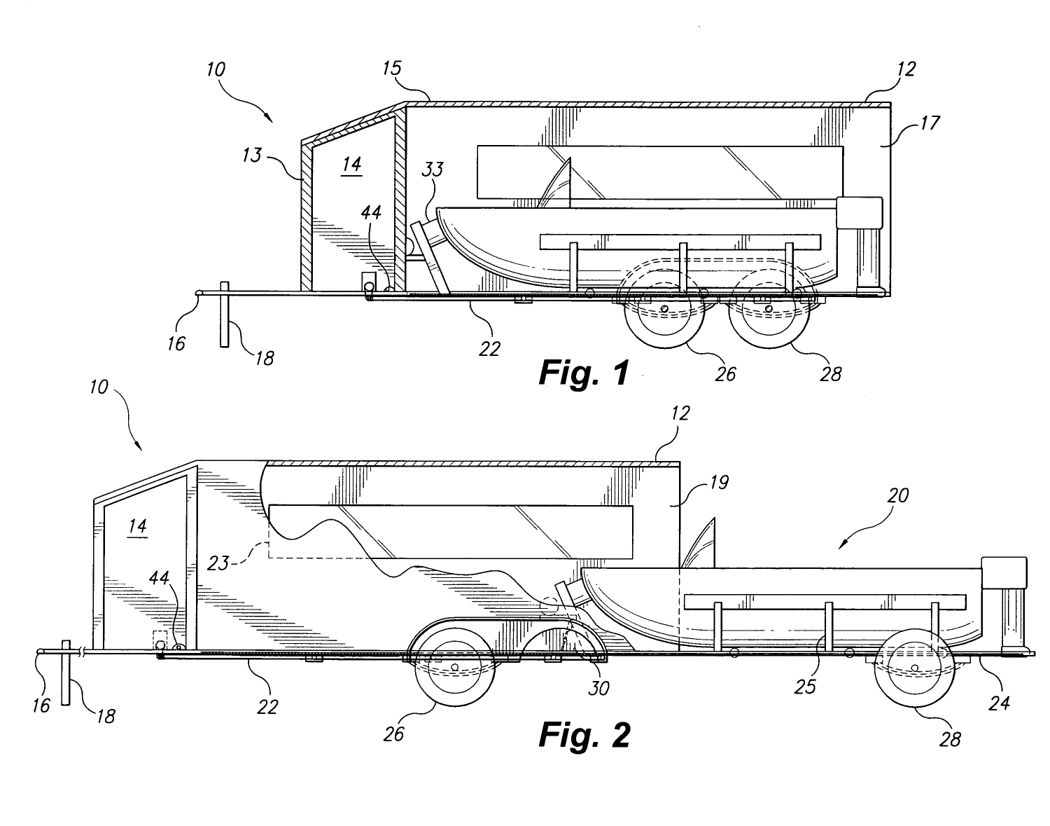

The present invention is directed to an enclosed boat trailer 10. As shown in FIGS. 1 and 2, boat trailer 10 includes a housing 12 having an antechamber 13, an upper wall 15, and a pair of sidewalls 17. The housing also preferably includes a roll-top rear door, although a hinged rear door 21 may be provided, if desired. Housing 12 defines an open interior region therein which is adapted for enclosing a boat 20 therein. Although shown as being a conventional motorboat 20, it should be understood that housing 12 may receive any suitable type of boat or conveyance. Housing 12 provides a protective enclosure for storing and transporting boat 20. Housing 12 is preferably formed from thermally insulated, structurally strong materials. As shown, a forward door 14 may be formed in the housing 12 to provide the user with access to the open interior region of housing 12.

The boat trailer 10 has a split chassis, including forward chassis 22 and rear chassis 24. Forward chassis 22 includes a frame mounted on front axle 42 and ground-engaging front wheels 26, a trailer hitch 16, and may include a trailer jack 18 for supporting the front end of the trailer 10 when the hitch 16 is not attached to a tow vehicle. Housing 12 is supported on the forward chassis 22. The forward chassis also supports wheels wells 30. Housing 12 may include a window 23 on one or both sides for observation of the boat 20 when stored within the trailer 10.

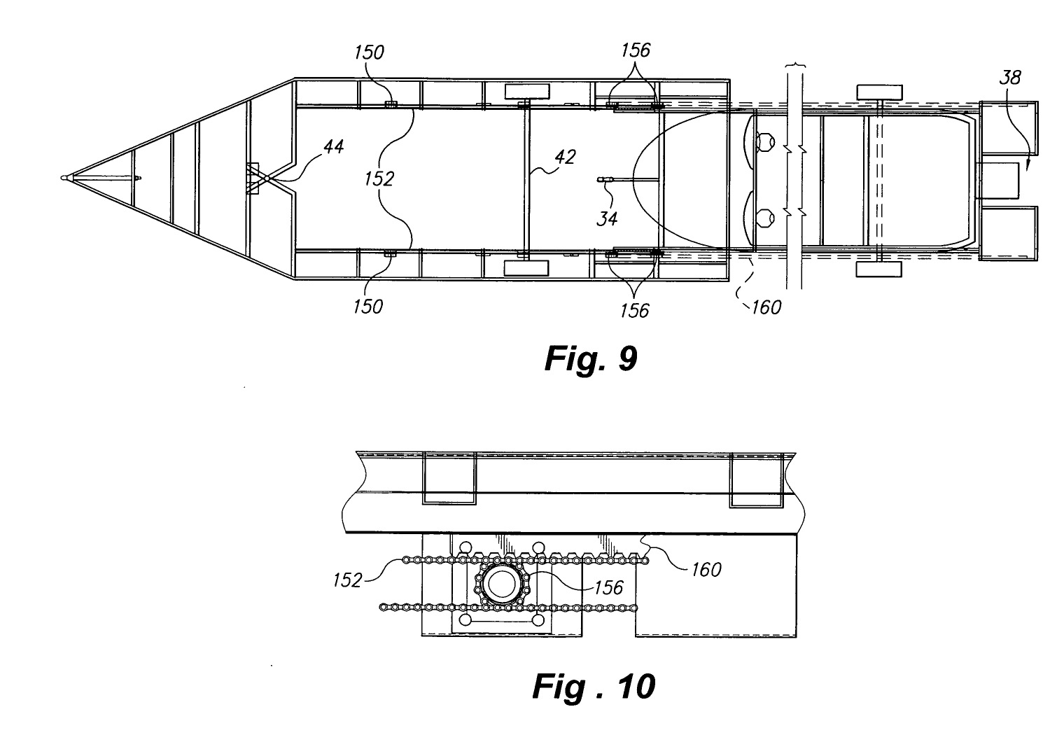

Rear chassis 24 is supported by rear axle 40 and ground-engaging rear wheels 28. The rear chassis 24 includes longitudinal frame rails that slidingly engage frame rails of front chassis 22. Rear chassis 24 supports a carriage or cradle 25 that is adapted to retain the boat 20. Rear chassis 24 may also support a floor or lower wall that extends rearward from antechamber 13 when the rear chassis 24 is slid fully forward. Rear chassis 24 is normally fixed to front chassis 22 by a clamp 34 on rear chassis 24 that releasably attaches to a receptacle 44 attached to front chassis 22. Member 34 is a locking mechanism which engages receptacle 44 (best shown in FIG. 9). Hand winch 33 is also provided, as shown, for connection to the boat 20. Rear chassis 24 may also support a pair of platforms 36 pivotally attached thereto that define a recess 38 therebetween when folded down to allow for passage of the boat's motor and propeller between the platforms 36.

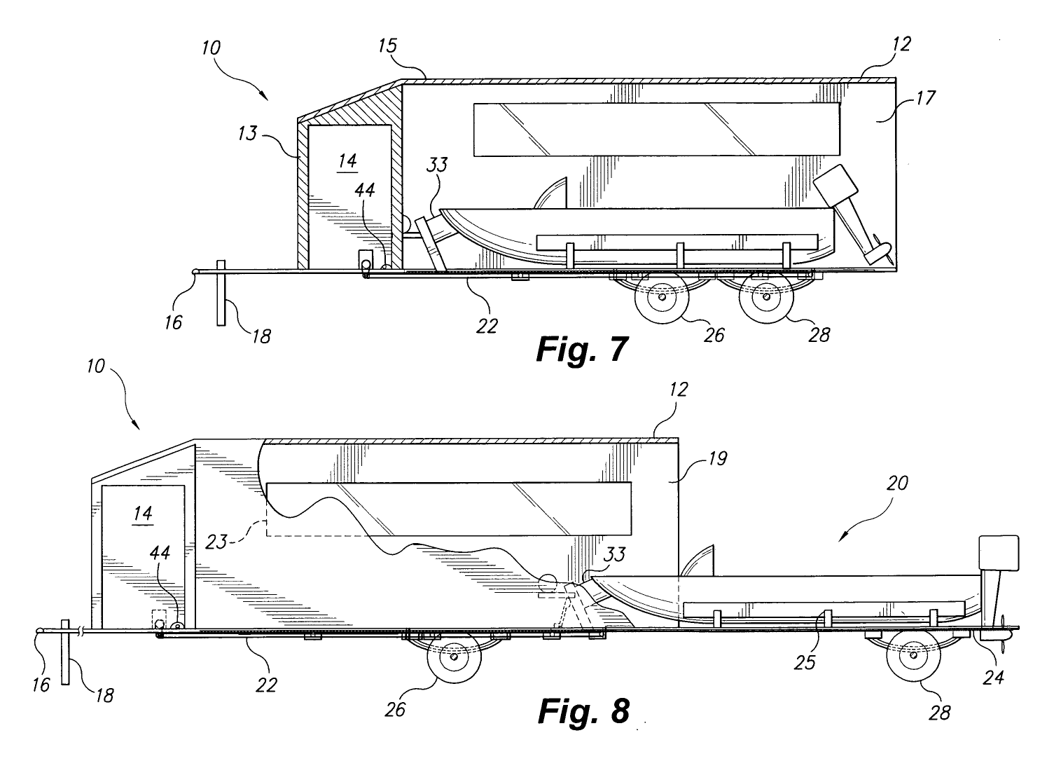

It should be understood that the contour and dimensions of the boat trailer shown in FIGS. 1-3 are shown for exemplary purposes only, and that the configuration of the boat trailer may be varied to accommodate the style of boat. For example, in the alternative embodiment of FIGS. 7-9, the trailer is adapted for use with a boat 20 having a differing profile than that shown in the previous embodiment. Further, wheels 26, 28 are smaller in the alternative embodiment and are shown as being alternatively positioned with respect to the floor of the trailer. Such alternative positioning and dimensions are optional and do not depart from the spirit or scope of the present invention. Similar alterations in dimension, contouring and configuration are shown in FIG. 9, although it should be understood that the extension of the rear chassis with respect to the housing and front chassis remains unchanged.

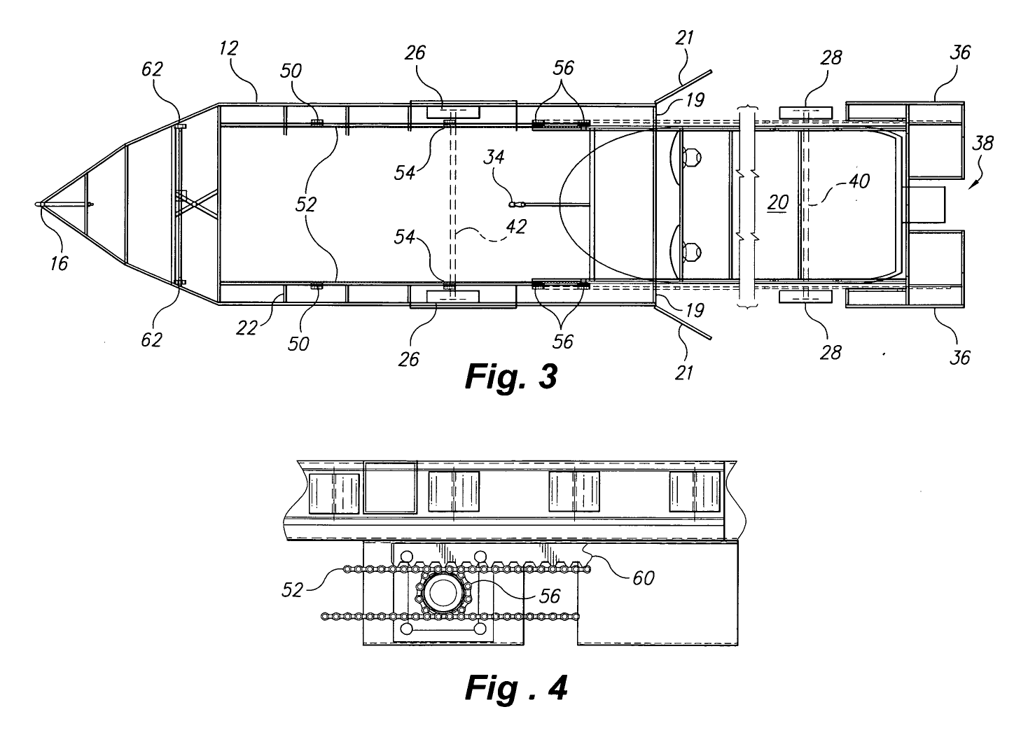

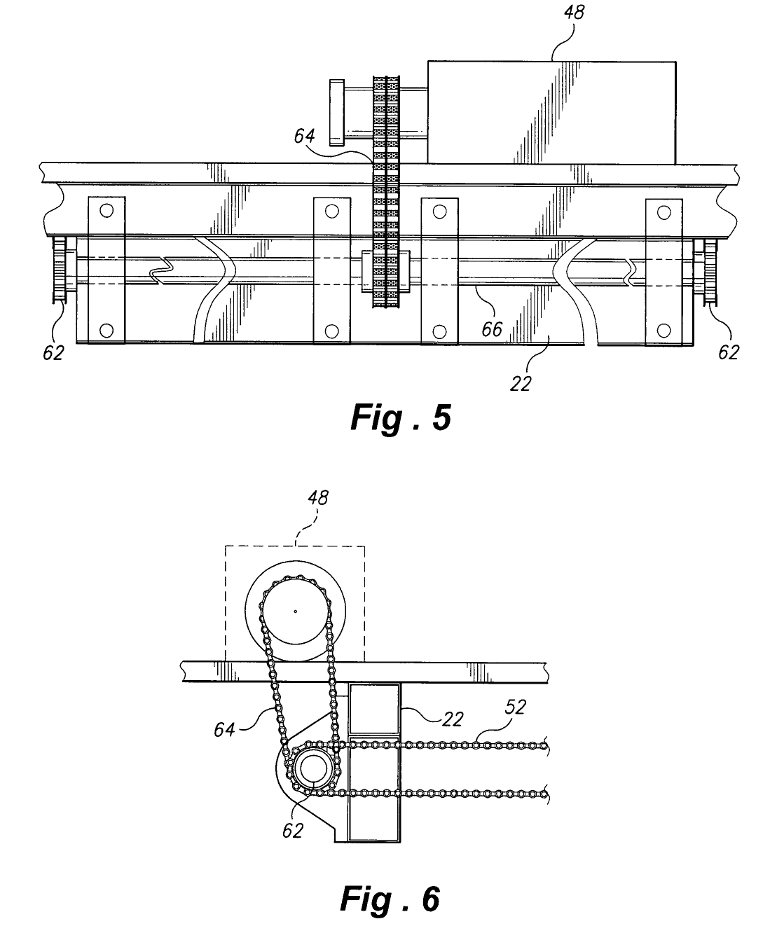

The trailer 10 includes a drive system, shown in FIGS. 3-6, for sliding the rear chassis forward and rearward. The drive system includes a drive motor 48, which may be a conventional 12-volt winch motor, disposed within the antechamber 13. As shown in FIGS. 5-6, the shaft of motor 48 includes one or more sprockets that drive chain(s) 64, which extend through a hole in the floor of the antechamber to engage one or more medially disposed sprockets that cause rotation of drive shaft(s) 66. Drive shaft(s) 66 have sprockets 62 attached to the lateral end(s) thereof.

Sprockets 62 drive chains 52 parallel to and somewhat lower than the frame rails of front chassis 22 and rear chassis 24. Chains 52 engage intermediate sprockets 50, 54 and rear sprockets 56. Racks 60 are mounted to the bottom surface of the frame rails of rear chassis 24. Intermediate sprockets 50, 54 and rear sprockets 56 are fixed to rotatably mounted shafts that have pinion gears coaxially mounted thereon medial to sprockets 50, 54 and 56, the pinions engaging racks 60. When clamp 34 is released and motor 48 is actuated, shafts 66 rotate, causing rotation of sprockets 50, 54 and 56, which, in turn, cause rotation of the pinions that engage racks 60 to slide rear chassis 24 forward or rearward, depending upon the direction of rotation of the motor 48. Instead of a chain drive coupled to rack and pinion gear system, any other linear translation system may be used to move rear chassis 24 forward and rearward, such as a hydraulic system using hydraulic rams.

In the above embodiment, rollers are utilized to smoothly deploy the rear chassis with respect to the front chassis. As best shown in FIG. 10, the rollers may be replaced with an angle iron slide rail stabilizing system. However, the functioning of the deployment remains essentially unchanged. In FIGS. 9 and 10, rack 160 engages drive chain 152 and the pinions of sprocket 156 in the same manner described above. Similarly, the drive chain 152 engages sprockets 150, as described above with regard to the embodiment of FIG. 3.

In use, the trailer 10 is backed up to the water's edge. The rear door(s) are opened, and platforms 36 are rotated down to either side of the boat's motor. The user enters the antechamber 13 through front door 14 and releases clamp 34. The user activates motor 48 to extend rear chassis 24 rearward, the boat 20 clearing the now open rear end 19 of the housing 12. The rear chassis 24 is submerged in the water, and a mooring rope tethers the boat 20 to a pier or other support. The boat 20 is released from the cradle 25 to float on the water, and the user activates motor 48 in the reverse direction to draw rear chassis 24 forward. Clamp 34 is secured to receptacle 44, and the trailer is driven away from the water's edge.

It will be obvious to those skilled in the art that instead of a boat cradle 25, rear chassis 24 may support a cradle for furniture, a motor vehicle, or any other type of cargo for which transport in an enclosed trailer is desired.

It is to be understood that the present invention is not limited to the embodiments described above, but encompasses any and all embodiments within the scope of the following claims.

I claim:

1. A boat trailer, comprising:
a front chassis having a frame mounted on a front axle and ground-engaging wheels, and a trailer hitch extending forward from the frame, the frame including longitudinally extending frame rails;
a housing mounted on the front chassis, the housing including a top wall, a pair of sidewalls, and at least one rear door, the housing defining an enclosure;
a rear chassis having a frame mounted on a rear axle and ground-engaging wheels, the rear chassis having longitudinally extending frame rails slidably engaging the front chassis frame rails;
a boat cradle mounted on the rear chassis adapted for supporting a boat;
means for releasably securing the rear chassis to the front chassis when the rear chassis is drawn fully forward;
a drive motor mounted in the housing; and
a linear drive system connected to the motor, the front chassis, and the rear chassis for extending the rear chassis from the housing and drawing the rear chassis forward into the housing.

2. The boat trailer as recited in claim 1, wherein the housing includes an antechamber, the pair of sidewalls extending rearwardly from the antechamber.

3. The boat trailer as recited in claim 1, wherein said means for releasably securing the rear chassis to the front chassis comprises a clamp mounted to said rear chassis, the clamp releasably and selectively engaging a recess formed in said front chassis.

4. The boat trailer as recited in claim 1, further comprising a pair of platforms pivotally attached to a rear end of said rear chassis, the pair of platforms defining a recess therebetween, whereby when the pair of platforms are folded into a lowered configuration, the recess is adapted for receiving at least part of the boat's motor.

5. The boat trailer as recited in claim 1, wherein said linear drive system comprises:
at least one rack mounted to a lower surface of said rear chassis;
at least one set of pinion gears rotatably mounted to said front chassis;
at least one chain and sprocket gear train extending between said drive motor and the at least one set of pinion gears, said drive motor driving rotation of the at least one set of pinion gears.

6. A boat trailer, comprising:
a front chassis having a frame mounted on a front axle and ground-engaging wheels, and a trailer hitch extending forward from the frame, the frame including longitudinally extending frame rails;
a housing mounted on the front chassis, the housing including a top wall, a pair of sidewalls, and at least one rear door, the housing defining an enclosure;
a rear chassis having a frame mounted on a rear axle and ground-engaging wheels, the rear chassis having longitudinally extending frame rails slidably engaging the front chassis frame rails;
a boat cradle mounted on the rear chassis adapted for supporting a boat;
means for releasably securing the rear chassis to the front chassis when the rear chassis is drawn fully forward;
a drive motor mounted in the housing; and
a rack-and-pinion drive system connected to the motor, the front chassis, and the rear chassis for extending the rear chassis from the housing and drawing the rear chassis forward into the housing.

7. The boat trailer as recited in claim 6, wherein the housing includes an antechamber, the pair of sidewalls extending rearwardly from the antechamber.

8. The boat trailer as recited in claim 6, wherein said means for releasably securing the rear chassis to the front chassis comprises a clamp mounted to said rear chassis, the clamp releasably and selectively engaging a recess formed in said front chassis.

9. The boat trailer as recited in claim 6, further comprising a pair of platforms pivotally attached to a rear end of said rear chassis, the pair of platforms defining a recess therebetween, whereby when the pair of platforms are folded into a lowered configuration, the recess is adapted for receiving at least part of a motor associated with the boat.

10. The boat trailer as recited in claim 6, wherein said rack-and-pinion drive system further comprises at least one chain and sprocket drive extending from said drive motor.
